(19) United States
(12) Patent Application Publication
(10) Pub. No.: US 2014/0032446 A1
(43) Pub. Date: Jan. 30, 2014

(54) Holistic Management of Portfolios that Include Separately Managed Accounts

(71) Applicant: Paul R. Samuelson, West Newton, MA (US)

(72) Inventor: Paul R. Samuelson, West Newton, MA (US)

(73) Assignee: LifeYield, LLC, Boston, MA (US)

(21) Appl. No.: 13/468,193

(22) Filed: May 10, 2012

Related U.S. Application Data
(60) Provisional application No. 61/484,725, filed on May 11, 2011.

(51) Int. Cl. G06Q 40/06

(52) U.S. Cl. 705/36 T

(57) ABSTRACT

Computer-implemented methods for transforming an investment portfolio that contains at least one separately-managed subaccount. Once instructions are received from a user with respect to cashflows, a net present value of future income is calculated for each separately managed subaccount considered as included within a taxable account or tax-advantaged account. A gap is then calculated between current and expected after-tax values of incremental withdrawals from each of the taxable and tax-advantaged accounts, as well as risk, tax, and location scores. On the basis of a combination score, putative trades are evaluated, with sales and purchases assigned to subaccounts, and the investment portfolio is transformed by implementing trades on the basis of the forgoing processes.

The present application claims the priority of U.S. Provisional Patent Application Ser. No. 61/484,725, filed May 11, 2011, and incorporated herein by reference.

### TECHNICAL FIELD

The present invention relates to computer-implemented portfolio management.

### BACKGROUND ART

A general rubric for the management of a portfolio of assets has been described in detail in U.S. patent application Ser. No. 12/545,969, filed Aug. 24, 2009 (Samuelson '969), entitled “Computer-Implemented Holistic Portfolio Management of Multiple Investment Accounts,” and is incorporated herein by reference. Inventions described herein may be of particular advantage in the context of portfolios encompassing multiple accounts, as described in Samuelson '969, however, not all of the embodiments described herein are limited to use in that context, and the scope of the present invention is not correspondingly limited.

A first issue encountered in the management of investment portfolios is that many investors hold a variety of securities with different tax treatments in a variety of investment accounts, which, may themselves, be subject to different tax treatments. Indeed, the securities held in one or more accounts may be intended for generating after-tax cash flows in multiple future periods.

Samuelson '969 taught that investors can increase their after-tax cash flows by managing their investments together in a coordinated fashion rather than addressing each account separately. In theory, investors can also increase their after-tax cash flows by more accurately anticipating the cumulative impact of their investment decisions made in each period. However, managing in a coordinated fashion becomes difficult when an investor, or his/her financial advisor, does not have control over an investment in a manner that would allow selling specific securities, such as IBM or AAPL, that are held as a portion of the investor's account. Such would be the case where an account is invested in a mutual fund or a managed account (referred to herein, jointly, as “MFMA”) where the underlying securities, and the buying and selling of them, are controlled, instead, by a mutual fund or by managed account provider who is not the same entity as either the investor or the investor's financial advisor.

### SUMMARY OF EMBODIMENTS OF THE INVENTION

In accordance with embodiments of the present invention, a computer-implemented method is provided for transforming an investment portfolio from a first state to a second state, wherein the investment portfolio is represented by data on a storage medium and includes a first account and a second account, each account comprising a plurality of assets. At least one of the first and second accounts includes assets within at least one separately managed subaccount, the separately managed subaccount pertaining to an identified type of a plurality of separately managed subaccount types and governed by a set of rules and specified objectives. The method has processes including the following:

a. receiving instructions from a user with respect to specified cashflows for the first account and the second account subject to any conditional target asset allocation;

b. employing software implemented on a computer to calculate a net present value of future income for each separately managed subaccount considered as included within the first account and the second account;

c. calculating a gap between current and expected after-tax values of incremental withdrawals from each of the first and second accounts;

d. employing software implemented on a computer to calculate for each of a plurality of putative incremental trades of an asset, including the plurality of subaccount types;
(1) a risk score equal to a rescaling of a marginal variance associated with the putative incremental trade;
(2) a tax score equal to a rescaling of a current capital gains tax liability net of an expected future capital gains tax liability; and
(3) a location score equal to a signed rescaling of the gap associated with the asset;

e. on the basis of a combination score equal to a function of said risk score, said tax score, and said location score, calculated for each of the putative incremental trades, implementing, solely in a memory of the computer, the putative incremental trade having the most favorable combination score;

f. iterating steps (d) and (e) accumulating incremental trades until the specified cashflow is met, subject to any conditional target asset allocation;

g. assigning security sales and purchases in the first and second accounts based on the accumulated incremental trades; and

h. transforming the investment portfolio by implementing trades in the first and second accounts on the basis of the cumulative operation of steps (d)-(g).

In accordance with other embodiments of the present invention, the first account may be a taxable account and the second account may be a tax-advantaged account.

In accordance with yet further embodiments of the present invention, a computer software program product is provided. The computer software program product is embodied in a tangible medium which, when loaded into a computer, performs the steps of one or more of the methods described above.

### BRIEF DESCRIPTION OF THE DRAWINGS

The foregoing features of the present invention will be more readily understood by reference to the following detailed description, taken with reference to the accompanying drawings, in which:

FIG. 1A is a flowchart showing a method, in accordance with one embodiment of the present invention, for transforming an investment portfolio from one state to another based on calculated optimal withdrawal amounts in the current and subsequent years;

FIG. 1B is a flowchart showing a method, in accordance with another embodiment of the present invention, for transforming an investment portfolio from one state to another based on calculated optimal withdrawal amounts in the current and subsequent years; and

FIG. 2 shows an embodiment of a general-purpose computer that may be used to implement aspects of the invention.

### DETAILED DESCRIPTION OF SPECIFIC EMBODIMENTS OF THE INVENTION

Definitions: As used herein and in any appended claim, an account “type” refers to whether an account, which may form a portion of an investment portfolio, is taxable, tax-deferred, tax-free or taxable variable annuity.

As used herein and in any appended claim, “investment accounts,” together, comprise the investment portfolio of an investor or investing entity.

In accordance with a first set of embodiments of the present invention, methods are provided for circumstances in which a portion of the assets of a portfolio are invested, or are under consideration for investment, in a “separately managed account,” which is an account characterized by the feature that the buying and selling of assets within the separately managed account are not directly controlled by the ultimate investor or by the ultimate investor's advisor. Examples of separately managed accounts include MFMAs (mutual funds or managed accounts). Description of the present invention herein may be couched in terms of MFMAs by way of example, but without limitation to the scope of the present invention as claimed in any appended claims.

A separately managed account may typically be characterized by what may be referred to as a “management style,” which, in turn, may be characterized in terms of various parameters such as: anticipated yield (on a periodic basis), anticipated price appreciation, and anticipated turnover rate. While specific trades within a separately managed account are not within the control of an investor, the investor may consider the management style of a separately managed account in evaluating investments in such an account.

Methods described herein may advantageously permit an investor to manage his investments in MFMAs more effectively in order to increase after-tax cash flows when cash is currently, or eventually, withdrawn. In particular, method described in detail below, may advantageously allow an investor to compare projected after-tax cash flows for securities individually held and controlled by the investor against those of MFMAs in a small number of different account types. Where a future withdrawal schedule is being considered, such comparisons may then be used as a basis for:
locating MFMAs (as opposed to individual securities that would be controlled by the investor) in the right type of account;
anticipating future capital gains taxes on MFMAs (in analogy to those that would be generated by selling individual securities controlled by the investor); and
anticipating the impact of withdrawal taxes of MFMAs (in analogy to those that would be generated by selling individual securities controlled by the investor).

In accordance with embodiments of the invention, inputs describing a small number of characteristics of the MFMAs are initially provided, as are a small number of characteristics of the investment accounts. All the inputs may be assembled by the investor, or by another party, such as the investor's financial advisor, on behalf of the investor. With the methods described in detail below, the investor may advantageously calculate the after-tax cash flows and use them, at the current time, as inputs to a portfolio rebalancing process to optimally locate MFMAs or to achieve other cash flow or asset allocation objectives. Moreover, within the scope of the present invention, the investor may also embed the methods described herein into a Monte Carlo simulation in order to validate the effectiveness of such methods in increasing after-tax returns with repeated use in future periods.

In particular, in accordance with embodiments of the present invention, two particular characteristics are assigned for each MFMA (here, taken to represent all separately managed accounts, as discussed above):

1. Yield Tax Rate: a tax rate assigned to the yield of each MFMA, which is typically the investor's tax rate on ordinary income for a security paying (taxable) interest income and the investor's tax rate on capital gains income for a security paying dividends (and assumed to be held longer than 90 days). MFMAs with more than one type of securities, the tax rate may be a blend.

2. Gain Tax Rate: a tax rate for the Holding Period assigned to the gain of each MFMA, which may be derived from its turnover rate and the anticipated withdrawal schedule

As used herein, and in any appended claim, the term “holding period” is defined to mean a period specified by the investor for retention in an account of a particular investment, to include a MFMA or other separately managed account. Thus, for example, a Gain Tax Rate is specified with respect to an identified “holding period.” Different “holding periods” may apply to different parts of MFMAs.

It is to be noted that that Gain Tax Rate inputs are important for equity MFMAs with substantial gains, while they are essentially irrelevant for fixed income MFMAs that produce very small gains. Holding periods may be irrelevant for some MFMAs (such as futures contracts and securities held short). For MFMAs with equities, a holding period of less than a year would require the investor's tax rate on ordinary income, while longer holding periods require the investor's tax rate on capital gains.

### Account Characteristics

Investors concerned about after-tax cash flows typically focus on two tax characteristics of accounts: whether there are taxes on income and gains (Gain Taxability), and whether there are taxes on account distributions (Withdrawal Taxability).

In accordance with embodiments of the present invention, an investor may assign these characteristics (gain taxability and withdrawal taxability) to accounts within the investor's portfolio. Taxes on income and gains are relevant for taxable accounts and not for tax-deferred (traditional IRA), tax-free (Roth IRA) and taxable variable annuities. Withdrawal taxes, on the other hand, are only relevant for tax-deferred accounts and taxable variable annuities. Most investors pay ordinary income taxes on taxable withdrawals. In accordance with embodiments of the present invention, investors may supply data with respect to Remaining Principal (per dollar investment) and Annual Exclusion for taxable variable annuity accounts (and some tax deferred accounts with after-tax contributions).

Additionally, in accordance with embodiments of the present invention, investors may define a withdrawal schedule for each type of account. Many investors will use their investment accounts to fund retirement income (with the remainder assigned as a bequest). A variety of withdrawal schedules may be accommodated within the scope of the present invention. Most schedules are defined by a starting date and an ending date and a rule for determining withdrawal levels (based either on a fixed schedule or dependent on remaining assets (and an annuity formula). In the case of a taxable account, an investor may assume a period for a partial step up (at the death of the first owner of a joint account) and a period for a full step up (at the death of the last account owner).

Additional inputs about accounts are employed, in accordance with the present invention, optionally, though not necessarily, in conjunction with MFMA inputs, to estimate more accurately the amount of capital gains taxes and withdrawal taxes expected to be paid in the future than would be possible in the absence of the additional inputs. Accordingly, an investor may advantageously assign each of his actual accounts to one of four types of accounts (simplifying his problem enormously), while capturing the important differences in tax treatment.

### After-Tax Cash Flows for Each Security for Each Account Type

An investor may use embodiments of the present invention to calculate after-tax cash flows for each individual security and MFMA in each account type for future periods conditional on the realization of expected appreciation. In alternate embodiments of the present invention, a wider range of appreciation may be considered for MFMAs. The approximate symmetry of tax treatment of gains and losses causes there to be little increase in accuracy for expected after-tax cash flows. Because after-tax cash flows occur in different periods, a conventional approach may be taken to discounting future cash flows back to their current values.

A preferred summary statistic for each security in each type of account is the net present value of future income (after adjusting for taxes and inflation), NPV. In accordance with preferred embodiments of the present invention, the following procedures are implemented with respect to a particular security or MFMA in a particular account, and typically (but not necessarily) repeated at an annual frequency:
Pre-tax gain and yield are calculated in dollars;
For a taxable account, taxes on the gain (using implied tax lots consistent with holding periods) and yield are calculated;
Using the new account value, a withdrawal is calculated using the withdrawal schedule;
For an account with taxes on withdrawals, the amount of exclusion for that withdrawal is calculated, the remaining principal is updated and taxes on withdrawals are calculated;
For taxable account, taxes on gain are recalculated taking into account the withdrawal;
The after-tax cash flow includes the withdrawal net of taxes;
The new account value, shares held (and tax lots for taxable accounts) are updated
The NPV for the security in the account is the sum of the discounted values of the after-tax cash flows in each period.

Conventional prior-art practice often compares pre-tax and after-tax returns for MFMAs in a single period. This comparison implicitly defines alternative investment accounts as either taxable or tax-free (excluding tax-deferred and taxable variable annuity accounts). This comparison does not adequately take into account different holding periods for MFMAs in taxable accounts, requiring an arbitrary assignment of capital gains rates.

The cumulative values of assets (and associated cash flows) depend on the length of the horizon and rules for determining withdrawals. These cannot be accurately estimated (or even correctly ranked) without a withdrawal schedule for each account type. The impact of taxes on withdrawals varies depending on the withdrawal schedule and the remaining principal of the account, as well as the pretax gain and yield of the security or MFMA. Conventional practice often fails to compare after withdrawal tax cash flows for securities or MFMAs in different types of tax free, tax deferred and variable annuity accounts. Investors assume that there are no benefits to optimally locating securities or MFMAs with different pretax gains and yields across these accounts.

### Account Rebalancing

Optimal rebalancing of accounts on a current basis typically involves evaluating the impact of purchases and sales of specific securities (or levels of investment in managed accounts). Sophisticated practice involves several steps: defining potential trades; calculating impact on after-tax cash flows; calculating taxes on capital gains; calculating transaction costs; Calculating impact on risk; and applying relevant restrictions on trades.

However, investors who hold MFMAs most often are not able to direct the MFMA provider to purchase or sell specific securities held in an MFMA, which prior to the invention described herein has made optimal tax management difficult if not impossible altogether. In accordance with embodiments of the present invention, an investor may define a trade in an MFMA as a single cash withdrawal instruction (for a sale) or a cash contribution instruction (for a purchase). For most investors in MFMAs, this is the only type of instruction available to them (because they cannot direct trades in individual securities held by the MFMA). The present invention may advantageously allow an investor to effectively examine the underlying securities in the MFMA (and their allocations) to determine the gain, yield, holding period characteristics required as inputs for individual securities. Conventional practice sometimes generates trades in individual securities for the MFMA (which cannot be executed) or makes simplistic assumptions about its composition. In contradistinction, embodiments of the present invention estimate capital gains taxes associated with a sale of securities in a taxable account by examining individual tax lots and using the available lot selection technique. This process may be extended to MFMAs by creating proportional trades in the underlying securities (selling a slice of the account) and using the manager's method for selecting tax lots to calculate capital gains.

Two important innovations, first made possible by teachings of the present invention, include:
allowing the simultaneous comparison of potential trades in securities and MFMAs across up to four different account types; and
providing estimates of after-tax net present values of future income (NPV) for securities and MFMAs in each account type as the basis of long term return impact.

Using the present invention, a framework and algorithms are provided that simultaneously compare trades based on their after-tax impacts across an investor's relevant set of account types. Most investors hold at least two types of accounts (taxable and tax deferred) and some hold (or contemplate holding) tax-free accounts and taxable variable annuities as well. Conventional practice typically requires investors to compare trades within single accounts or within a single type of account. Methods in accordance with the present invention may advantageously simplify the instructions to be provided by an investor, and, at the same time, improve trade recommendations based on simultaneous comparisons.

Estimates of NPV for each MFMA in each (relevant) account type provide the most accurate and relevant measure of impact of trades on after-tax cash flows. The NPV measure estimates accurately taxes on gains and yield (when relevant) and taxes on withdrawals over the investor's investment horizon. Application of methods in accordance with the teachings of the present invention allows distinction between equity MFMAs based on their management of capital gains. Conventional practice has ignored these differences, despite their very substantial impacts on after-tax cash flows.

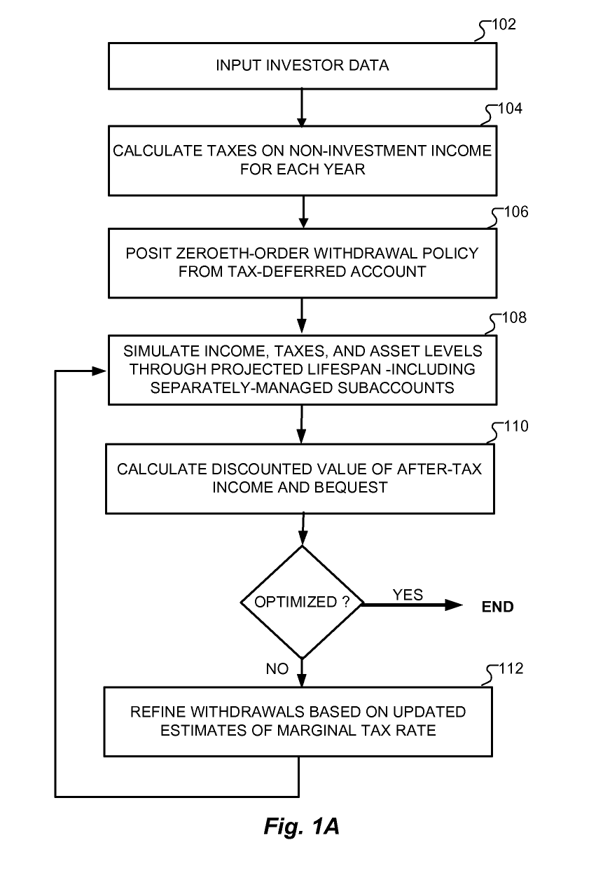

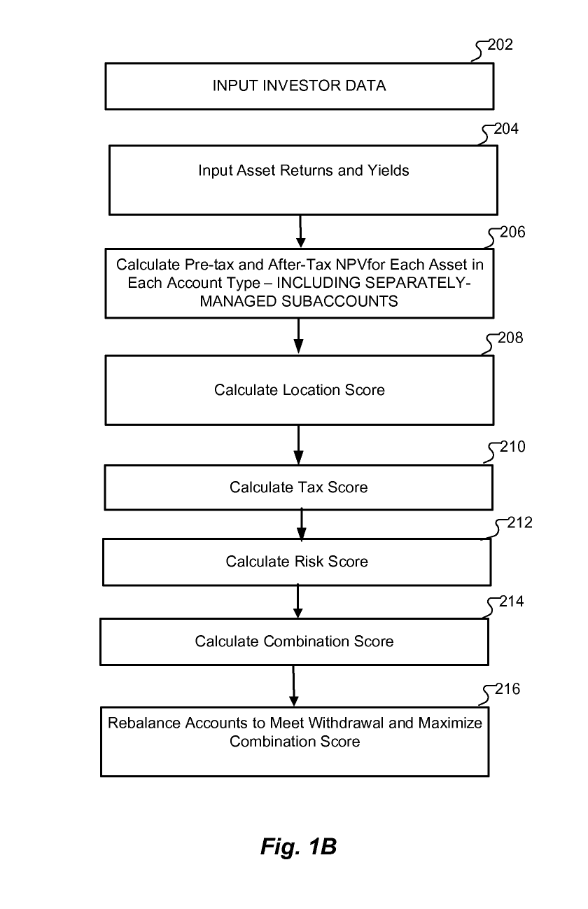

An algorithm, in accordance with an embodiment of the present invention and described now with reference to FIG. 1A, proceeds in an iterative process in determining the optimal withdrawal amounts in the current and subsequent years. It should be noted that the investor only needs to implement the recommendation for the current year and will have an opportunity to revise his withdrawal amounts in the following year with updated inputs.

The process follows a sequence of steps, which can be summarized for a simple example. Suppose there is a single investor, age 60 retiring at 65, with assets in taxable, tax deferred and tax free accounts. In a first step, investor data are inputted (102) into memory of a processor. If the investor has no discretion over taxable variable annuities, then they can be treated as part of his other income. If the individual has low risk investments and low planned withdrawals, then he can assume a fixed sequence of after-tax income (deriving from other income and withdrawals from accounts). If this is not the case, then an additional calculation in each year is required to determine the target after-tax income (which will depend on the account values and years of retirement remaining)

After investor data have been inputted, an algorithm first calculates (104) the taxes in each year on other income (saving the maximum marginal tax rate) and the income after taxes, using standard tax calculation tables, and, for MFMAs, and other separately managed accounts, applying the novel techniques that have been described, in detail, above. Typically, income and marginal tax brackets will be at a relatively high level prior to retirement and a low level after retirement.

Second, an algorithm is used to guess a withdrawal policy (106) for the tax-deferred account: withdrawing the minimum prior to retirement (zero) and then withdrawing equal amounts over the expected lifespan (for example 1/20^{th} if lifespan extends for 20 years 66 to 85). The algorithm can also make a guess that the taxable account should be used until it is exhausted to pay all taxes, fund the residual need for after-tax income, and make a contribution to the tax free account (in excess of RMD beginning at age 70).

Using this set of withdrawal policies, an algorithm simulates (108) the income, taxes and asset levels through a projected life span, say, till age 85, and the net account values (and taxes) if death occurs in the following year. As part of this process, the algorithm retains the marginal tax rate in each year as well as the contributions to taxable income from tax-deferred withdrawals and investment income in the taxable account. The algorithm also calculates (110) the discounted value of the after-tax income and bequest.

Next, withdrawal decisions are refined (112) based on the sequence of marginal tax rates. Depending on the relative value of the tax-deferred account, the largest amount of discretionary taxable income comes from the size of the voluntary withdrawal from the tax deferred account. The algorithm will shift withdrawals from the tax-deferred account away from years with higher marginal tax rates and toward years with lower marginal tax rates. The algorithm will stop, when there are no further improvements available in the discounted value of after-tax income and bequest.

An algorithm, in accordance with another embodiment of the present invention is now described with reference to FIG. 1B. In a first step, investor data are inputted (202) into memory of a processor. Then, asset returns and yields are inputted (204), similarly, into memory of a processor.

Pre-tax and after-tax net present value (NPV) are then calculated (206) using techniques known in the art, except with respect to separately-managed accounts, where the novel techniques described above are applied. Location scores are then calculated (208) calculated (208) for each asset of each account type, Tax scores (210), risk scores (212), and combination scores (214) are also calculated, as taught in detail in Samuelson '969. All accounts are then rebalanced (216) to meet a specified withdrawal and to maximize the combination score, in accordance with the teachings of Samuelson '969, for example.

Various embodiments according to the invention may be implemented on one or more computer systems. These computer systems may be, for example, general-purpose computers. It should be appreciated that one or more of any type computer system may be used to perform some or all of the steps of the embodiments described herein. Further, the software design system may be located on a single computer or may be distributed among a plurality of computers attached by a communications network.

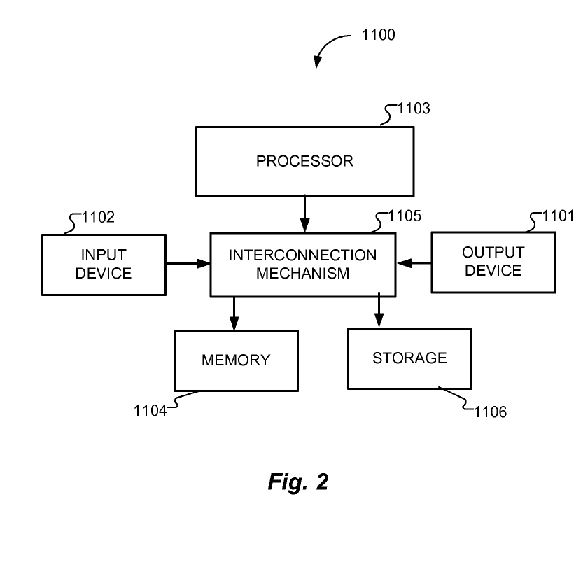

Various aspects of the invention may be implemented as specialized software executing in a general-purpose computer system 1100 such as that shown in FIG. 2. The computer system 1100 may include a processor 1103 connected to one or more memory devices 1104, such as a disk drive, memory, or other device for storing data. Memory 1104 is typically used for storing programs and data during operation of the computer system 1100. Components of computer system 1100 may be coupled by an interconnection mechanism 1105, which may include one or more busses (e.g., between components that are integrated within a same machine) and/or a network (e.g., between components that reside on separate discrete machines). The interconnection mechanism 1105 enables communications (e.g., data, instructions) to be exchanged between system components of system 1100. Computer system 1100 also includes one or more input devices 1102, for example, a keyboard, mouse, trackball, microphone, touch screen, and one or more output devices 1101, for example, a printing device, display screen, speaker. In addition, computer system 1100 may contain one or more interfaces (not shown) that connect computer system 1100 to a communication network (in addition or as an alternative to the interconnection mechanism).

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 1100 is shown by way of example as one type of computer system upon which various aspects of the invention may be practiced, it should be appreciated that aspects of the invention are not limited to being implemented on the computer system as shown in FIG. 2. Various aspects of the invention may be practiced on one or more computers having a different architecture or components that that shown in FIG. 2.

Computer system 1100 may be a general-purpose computer system that is programmable using a high-level computer programming language. Computer system 1100 may be also implemented using specially programmed, special purpose hardware. In computer system 1100, processor 1103 is typically a commercially available processor. The processor typically executes an operating system.

The processor 1103 and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate, or interpreted code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A computer-implemented method for transforming an investment portfolio from a first state to a second state for purposes of single-period rebalancing, wherein the investment portfolio is represented by data on a storage medium and includes a taxable account and a tax-advantaged account, each comprising a plurality of assets,
wherein at least one of the taxable and retirement accounts includes assets within at least one separately managed subaccount, the separately managed subaccount pertaining to an identified type of a plurality of separately managed subaccount types and governed by a set of rules and specified objectives, the method comprising:
a. receiving instructions from a user with respect to specified cash flows for the taxable account and the tax-advantaged account subject to any conditional target asset allocation;
b. calculating in a first procedure carried out in a computer a net present value of future income considered as included within the taxable account and the tax-advantaged account;
c. calculating in a second procedure carried out in a computer a gap between current and expected after-tax values of incremental withdrawals from each of the taxable and tax-advantaged accounts;
d. calculating in a third procedure carried out in a computer, for each of a plurality of putative incremental trades of an asset, including the plurality of subaccount types;
(1) a risk score equal to a rescaling of a marginal variance associated with the putative incremental trade;
(2) a tax score equal to a rescaling of a current capital gains tax liability net of an expected future capital gains tax liability; and
(3) a location score equal to a signed rescaling of the gap associated with the asset;
e. on the basis of a combination score equal to a function of said risk score, said tax score, and said location score, calculated for each of the putative incremental trades, determining in a fourth procedure carried out in a computer which of the putative incremental trades has a combination of risk score, tax score and location score that is most favorable according to pre-established criteria;
f. iterating processes (d) and (e) accumulating incremental trades until the specified cashflow is met, subject to any conditional target asset allocation;
g. assigning security sales and purchases in the taxable and retirement accounts based on the accumulated incremental trades; and
h. transforming the investment portfolio by implementing trades in the taxable and retirement accounts and individual tax-advantaged accounts on the basis of the cumulative operation of processes (d)-(g).

2. A computer-implemented method for transforming an investment portfolio from a first state to a second state for purposes of single-period rebalancing, wherein the investment portfolio is represented by data on a storage medium and includes a first account and a second account, each comprising a plurality of assets,
wherein at least one of the first and second accounts includes assets within at least one separately managed subaccount, the separately managed subaccount pertaining to an identified type of a plurality of separately managed subaccount types and governed by a set of rules and specified objectives, the method comprising:
a. receiving instructions from a user with respect to specified cashflows for the first account and the second account subject to any conditional target asset allocation;
b. employing software implemented on a computer to calculate a net present value of future income for each separately managed subaccount considered as included within the first account and the second account;
c. calculating a gap between current and expected after-tax values of incremental withdrawals from each of the first and second accounts;
d. employing software implemented on a computer to calculate for each of a plurality of putative incremental trades of an asset, including the plurality of subaccount types;
(1) a risk score equal to a rescaling of a marginal variance associated with the putative incremental trade;
(2) a tax score equal to a rescaling of a current capital gains tax liability net of an expected future capital gains tax liability; and
(3) a location score equal to a signed rescaling of the gap associated with the asset;
e. on the basis of a combination score equal to a function of said risk score, said tax score, and said location score, calculated for each of the putative incremental trades, implementing, solely in a memory of the computer, the putative incremental trade having the most favorable combination score;
f. iterating steps (d) and (e) accumulating incremental trades until the specified cashflow is met, subject to any conditional target asset allocation;
g. assigning security sales and purchases in the first and second accounts based on the accumulated incremental trades; and
h. transforming the investment portfolio by implementing trades in the first and second accounts on the basis of the cumulative operation of steps (d)-(g).

3. A computer software program product for transforming an investment portfolio for purposes of single period rebalancing, the computer program product comprising a computer usable medium having computer readable program code thereon, the computer readable program code including:
a. a routine for receiving instructions from a user with respect to specified cash flows for the taxable account and the tax-advantaged account subject to any conditional target asset allocation;
b. a routine for calculating a net present value of future income for each separately managed subaccount considered as included within the taxable account and the tax-advantaged account;
c. a routine for calculating a gap between current and expected after-tax values of incremental withdrawals from each of the taxable and tax-advantaged accounts;
d. a routine for calculating each of a plurality of putative incremental trades of an asset, including the plurality of subaccount types;
(1) a risk score equal to a rescaling of a marginal variance associated with the putative incremental trade;
(2) a tax score equal to a rescaling of a current capital gains tax liability net of an expected future capital gains tax liability; and
(3) a location score equal to a signed rescaling of the gap associated with the asset;
e. a routine for calculating, on the basis of a combination score equal to a function of said risk score, said tax score, and said location score, which of the putative incremental trades has a combination of risk score, tax score and location score that is most favorable according to pre-established criteria;
f. a routine for assigning security sales and purchases in the taxable and retirement accounts based on the accumulated incremental trades.
